(19) United States
(12) Patent Application Publication
(10) Pub. No.: US 2005/0103764 A1
(43) Pub. Date: May 19, 2005

(54) Laser cutting machine with two X-axis drives

(75) Inventor: Leonid Zeygerman, West Hartford, CT (US)

Correspondence Address: PEPE & HAZARD, LLP, 225 ASYLUM ST., HARTFORD, CT, 06103, US

(73) Assignee: Trumpf, Inc.

(21) Appl. No.: 10/992,048

(22) Filed: Nov. 18, 2004

Related U.S. Application Data
(63) Continuation-in-part of application No. 10/676,552, filed on Oct. 1, 2003.
(63) Continuation-in-part of application No. 10/755,738, filed on Jan. 12, 2004, now Pat. No. 6,825,439.

(51) Int. Cl. B23K 26/08

(52) U.S. Cl. 219/121.78

(57) ABSTRACT

A machine tool for machining workpieces by motion of a machining tool relative to the workpiece has a worktable and a frame extending above the worktable. An X-axis motion unit is movable along the X-axis in a first range of motion. A first machining tool mount is movably mounted on the motion unit for movement in the Y-axis in a second range of motion, and a second machining tool mount is movably mounted on the first machining tool mount for movement in the X-axis within a third range of motion of lesser length than, and within the length of, said first range of motion. A machining tool is mounted on the second machining tool mount, and drives motors are provided for the motion unit on the frame, the first machining tool mount and the second machining tool mount in their respective ranges of motion and axes. A computer control effects operation of the several drive motors to move the machining tool in the X- and Y-axes and to drive the second machining tool mount more rapidly in the X-axis.

### CROSS REFERENCE TO RELATED APPLICATIONS

The present application is a continuation-in-part of U.S. patent application Ser. No. 10/676/552 filed Oct. 1, 2003 and U.S. patent application Ser. No. 10/755,738 filed Jan. 12, 2004.

### BACKGROUND OF THE INVENTION

The present invention relates to machine tools, and, more particularly, to machine tools in which the machining head is moved in multiple axes relative to the workpiece.

In laser cutting installations and other machining operations involving large plate-like workpieces, it is common to support the workpiece on a worktable and to effect relative movement between the machining head and the workpiece. Although the workpiece on the worktable can be moved relative to the machining head, generally it is preferable to mount the machining tool on a support located above the workpiece and to move the support with the machining head thereon relative to the workpiece computer control. Typically, the support for the machining head is a bridge which extends in a first axis between the side rails of the machine and on which it is movable relative to the workpiece in the other axis. Moreover, the machining head is generally supported on the bridge so that it is movable along the length of the bridge in the first axis, thus providing relative motion of the machining head in both X and Y directions.

As will be readily appreciated, the bridge is a substantial structure with a relatively large mass so that motion of the bridge requires substantial power to overcome the inertia and to effect the continued motion. The power for movement of the cutting head relative to the bridge in the transverse direction is much less because the machining head is lighter than the bridge and has lesser inertia so that it moves rapidly along the length of the bridge.

Because of the large mass which creates inertia to be overcome and the need to stop the motion of the bridge produces momentum to be overcome, the cutting action of small intricate contours may not be as precise as is desirable. The costs and wear of the drive system for the bridge can adversely affect the economics if the types of parts to be processed in a particular machine tool installation are small and of intricate configuration.

In U.S. patent application Ser. No. 10/156,886 filed May 2, 2002, Applicant and co-inventors have described and claimed a laser cutting machine in which a support is movable on the machine frame in the X-axis and a motion unit containing the laser cutting head is movable on the support in the Y-axis. In this installation, the laser cutting head is mounted in a lightweight unit which can be moved relative to the motion unit in the Y-axis.

In U.S. patent application Ser. No. 10/755,738 filed Jan. 12, 2004, Applicant and the co-inventors have generically claimed an installation in which there is a second drive for a relatively lightweight unit containing the cutting head in one of the two horizontal axes.

In U.S. patent application Ser. No. 10/616,552 filed Oct. 1, 2003, Applicant and co-inventors have described a laser machining installation in which a motion unit moves back and forth-on a machine frame coupled with loading and unloading mechanisms. Although the motion unit has considerably less mass than the movable bridge which is widely employed, there is still substantial inertia and momentum to be overcome which affect the ability to produce small accurate contours.

As used herein, the terms “one axis” and “other axis” shall each refer respectively to one of the mutually perpendicular horizontal X- and Y-axes, and to the other of the X- and Y-axes. The term “Z-axis” shall refer to a vertical axis.

Accordingly, it is an object of the present invention to provide a novel machine tool in which the motion required of a relatively massive machining head support is substantially reduced for the machining of relatively small parts.

It is also an object to provide such a machine tool in which the quality of the machining of small intricate contours is improved.

Another object is to provide such a machine tool installation which can be fabricated readily and which is relatively simple to operate.

### SUMMARY OF THE INVENTION

It has now been found that the foregoing and related objects may be readily attained in a machine tool for machining workpieces by motion of a machining tool relative to a worktable having X- and Y-axes and adapted to support a workpiece thereon, and a motion unit disposed above the worktable and movable on the machine frame along the X-axis of the worktable in a first range of motion.

First machining tool mounting means is movably mounted on the motion unit for movement along the motion unit in the Y-axis in a second range of motion, and second machining tool mounting means is movably mounted on the first machining tool mounting means for movement in the X-axis relative to the motion unit within a third range of motion of lesser length than, and within the length of, the first range of motion. The machining tool is mounted on the second machining tool mounting means.

First drive means is provided for the support to move the motion unit in the X-axis over the worktable in the first range of motion. Second drive means is provided for the first machining tool mounting means to move the first machining tool mounting means in the Y-axis along the motion unit in the second range of motion. Third drive means is provided for moving the second machining tool mounting means in the X-axis relative to the first machining tool mounting means in the third range of motion. A computer control is provided to effect operation of the first and second drive means to move the machining tool in the X- and Y-axes and for effecting operation of the third drive means for rapid movement of the machining tool in the X-axis to machine a workpiece supported on the worktable.

Usually, the machining tool is supported on the second machining tool mounting means for vertical movement in a Z-axis in a fourth range of motion, and the machine tool includes fourth drive means for moving the machining tool in the Z-axis. The computer control also effects operation of the fourth drive means.

Desirably, the computer control also includes means for determining whether a desired length of movement in the X-axis is within the third range of motion of the second machining tool mounting means on the first machining tool mounting means to effect the desired movement by the third drive means. The computer control includes means for determining whether a desired length of movement in the X-axis is beyond the third range of motion of the second machining tool mounting means and for effecting the desired movement of the machining tool in the X-axis by operation of the first drive means to move the motion unit and by operation of the third drive means to move the second machining tool mounting means. The computer control includes means for effecting a large displacement of the motion unit in the X-axis to reposition the machining tool relative to the workpiece and thereafter for effecting a smaller displacement of the second machining tool mounting means in the X-axis to effect machining of the workpiece in the X-axis.

Preferably, the machining tool is a laser cutting head which is mounted in a housing providing the second machining tool mounting means and slidable on guides supported on a housing providing the first machining tool mounting means and movable on the support in the X-axis.

### BRIEF DESCRIPTION OF THE DRAWINGS

FIG. 1 is an exploded view of the principal components of a laser cutting installation embodying the present invention;

FIG. 2 is a side elevational view of the motion unit in FIG. 1 drawn to enlarged scale;

FIG. 3 is a perspective view of the motion unit;

FIG. 4 is a front elevational view of the motion unit;

FIG. 5 is a bottom view of the motion unit; and

FIG. 6 is a top plan view of the motion unit.

### DETAILED DESCRIPTION OF THE ILLUSTRATED EMBODIMENT

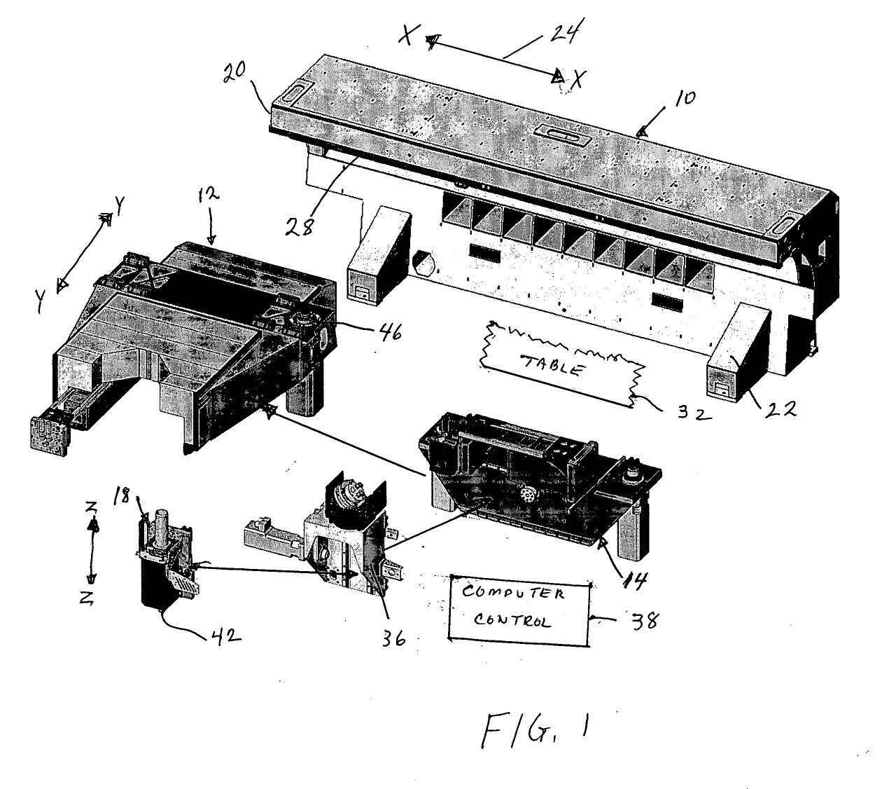

Turning first to FIG. 1, therein illustrated is a laser cutting installation embodying the present invention and generally comprised of an elongated machine frame generally designated by the numeral 10 and which has an arm 20 which extends over the diagrammatically illustrated worktable designated by the numeral 32. The installation also includes an X-axis motion unit generally designated by the numeral 12, a Y-axis motion unit generally designated by the numeral 14, an X2-axis motion unit generally designated by the numeral 16, and a Z-axis motion unit 18.

The arm 20 of the frame 10 has racks 28 on which is mounted the X-axis motion unit 12 to move along the X-axis indicated by the arrow 24. Diagrammatically illustrated is a computer control 30 which controls the movement of the motion units. The work support table 32 is positioned within the area bounded by the side supports 22 of the frame 10.

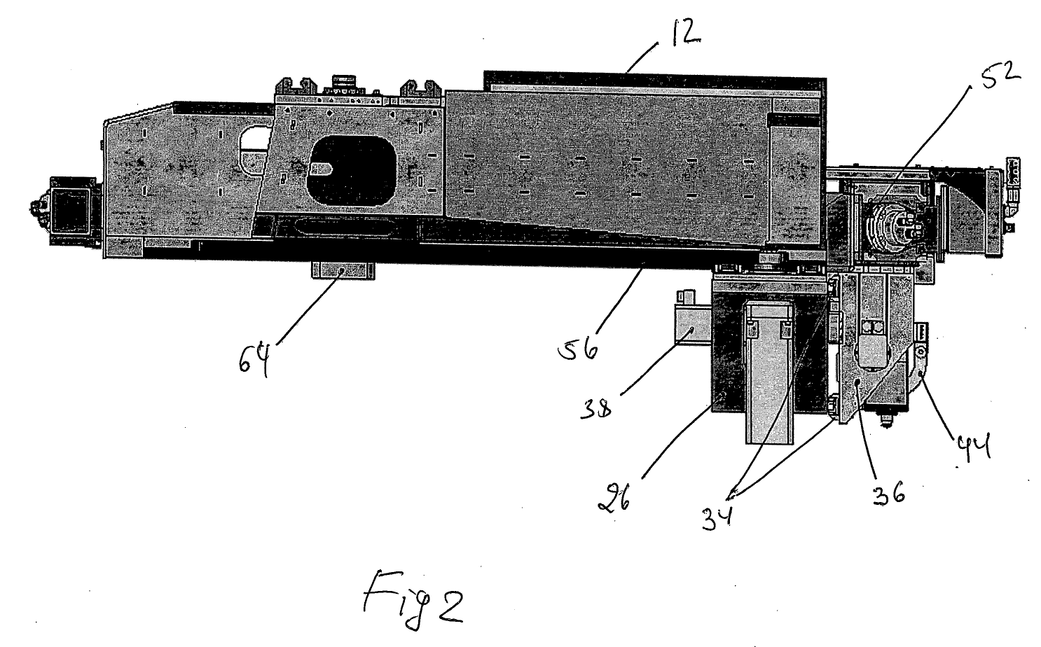

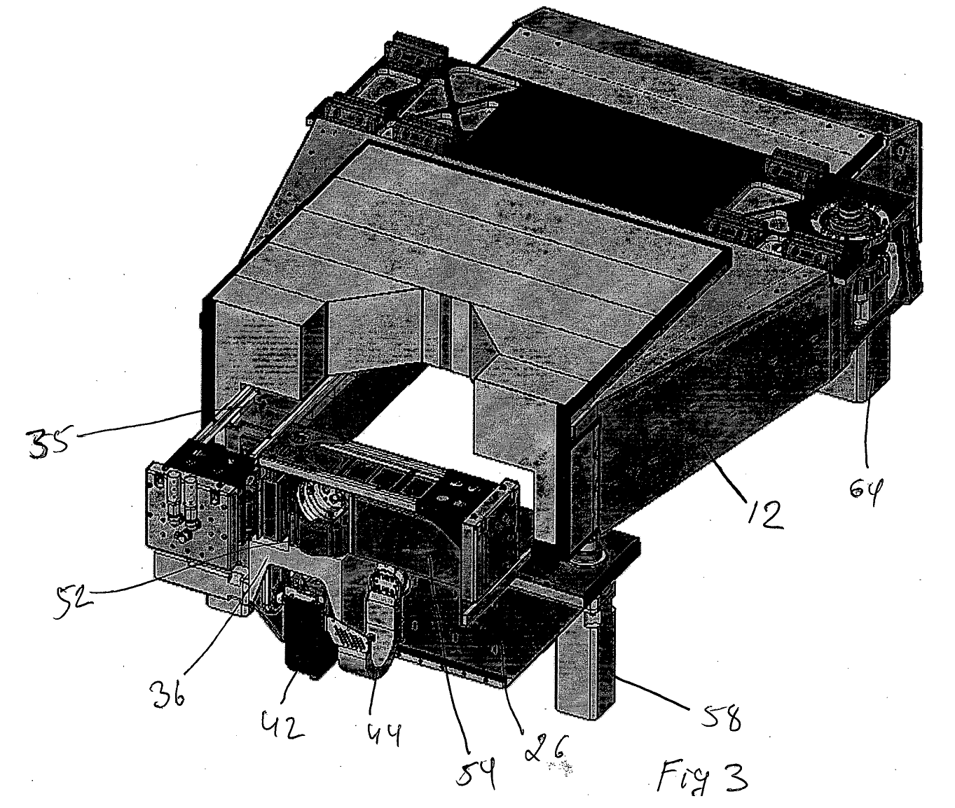

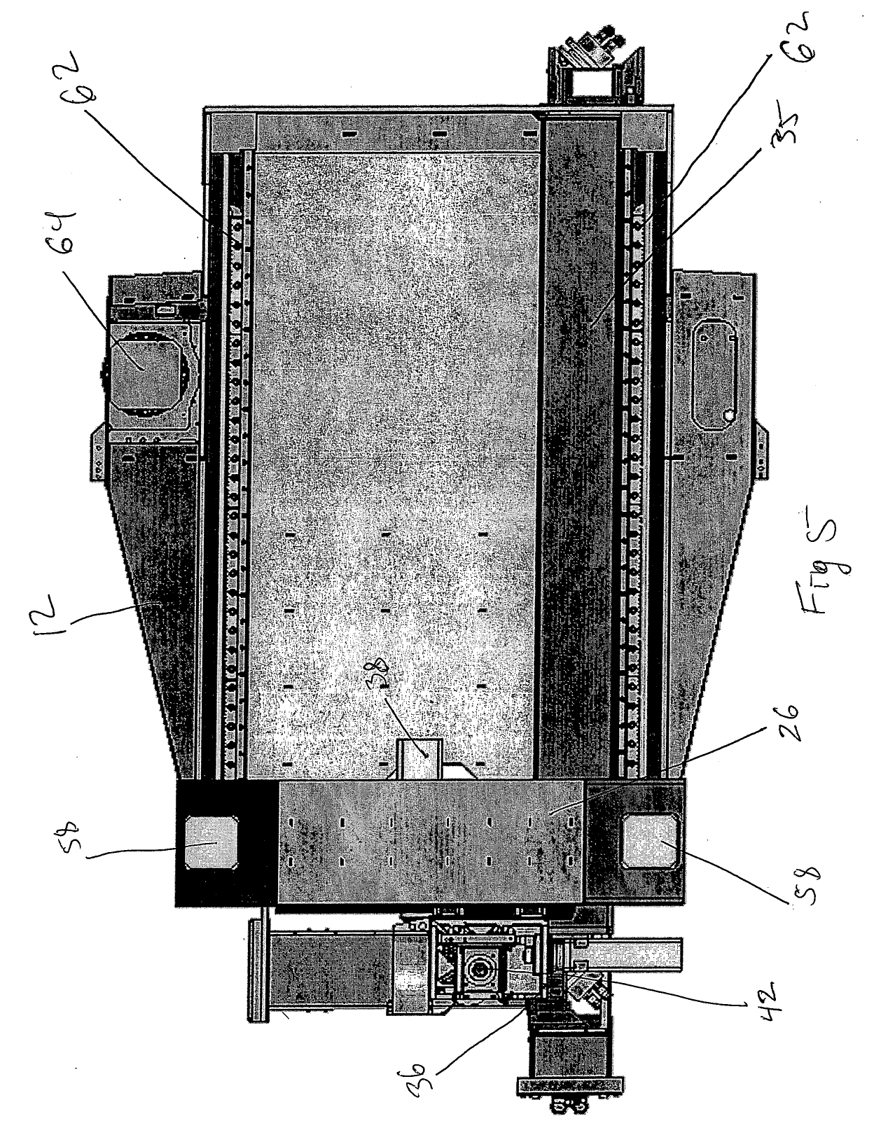

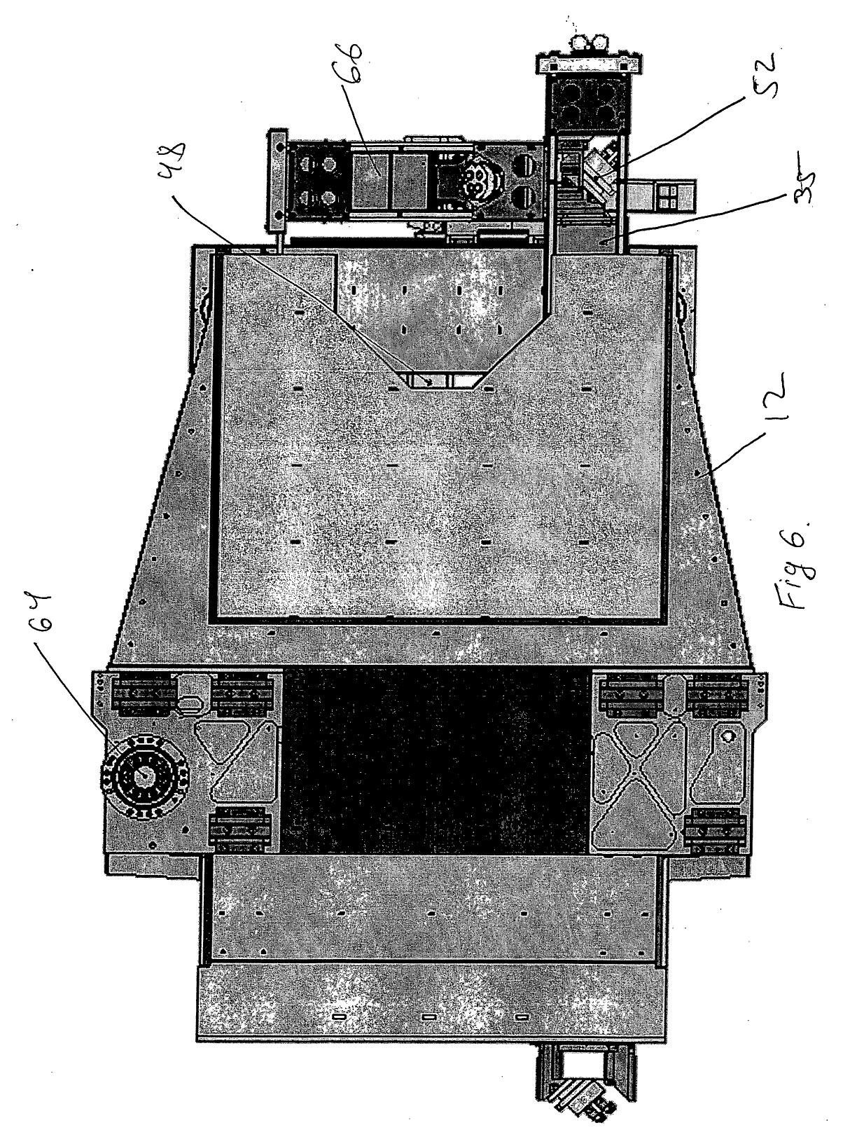

Movably supported on the X-axis motion unit 12 is the Y-axis motion unit generally designated by the numeral 14 and illustrated in FIGS. 2-6. The X-axis motion unit 12 moves along the elongated racks 28 by engagement of the pinions 46 on the drive motors 64.

The Y-axis motion unit 14 includes the X2-axis motion unit 16 which is supported on the Y-axis motion unit 14 for movement in the X-axis along the guides 34.

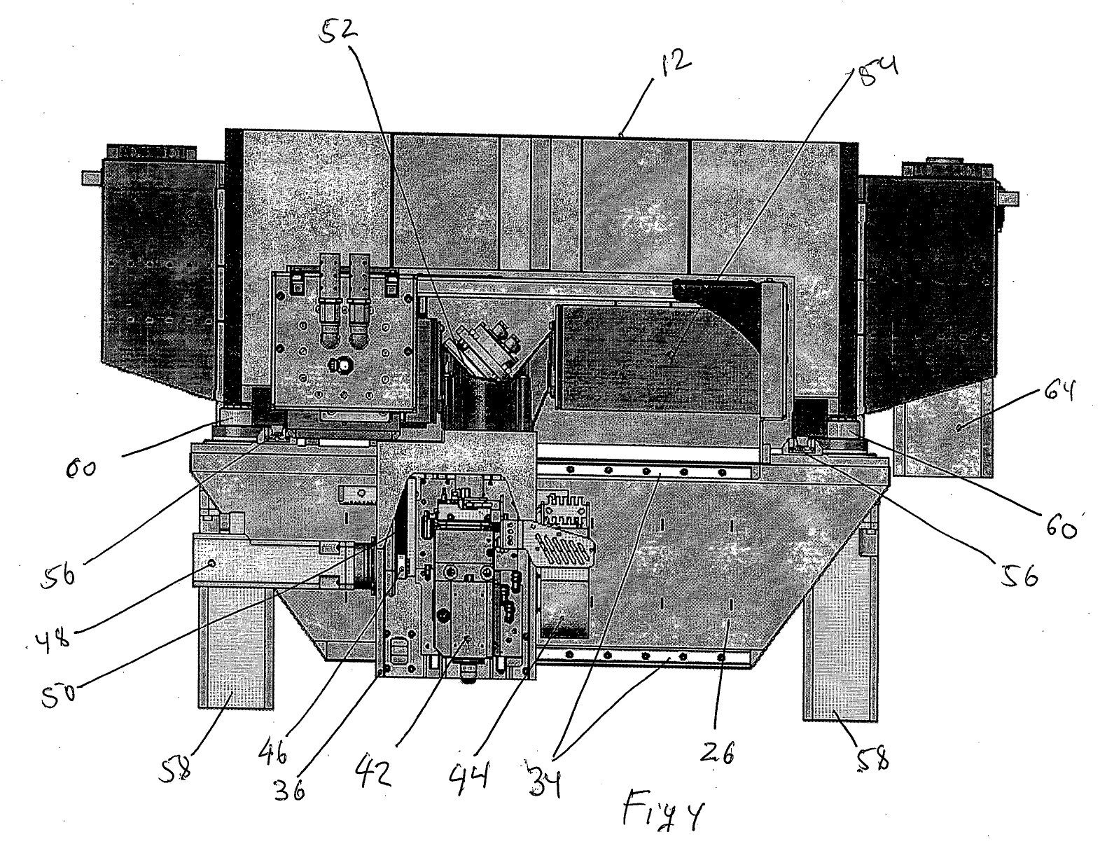

Turning in detail to FIG. 4, the Y-axis motion unit 14 has a pair of vertically spaced horizontal guides 34 for movement of the X2-axis motion unit 16 therealong. The X2-axis drive motor 38 effects the controlled motion.

The laser cutting head 18 is movable vertically in the X2-axis motion unit 36 by a cable/chain drive 44 which is driven by the pinion 46 on the drive motor 48 which meshes with a Z-axis rack 50. The laser beam is directed into the optics of the cutting head 42 by the 90° bending mirror block 52 upon which the beam traveling through the X2-axis beam bellows 66 impinges.

The Y-axis motion unit 26 is movable along the Y-axis guides 56 by the Y-axis motors 58 which have pinions 60 meshing with the racks 62 and the beam travels through the beam bellows 35.

The X-axis motion unit 12 is driven along the arm 20 by the X-axis motors 64 which have pinions engaged with the racks 28.

In operation, the computer control 30 operates the several drive motors 38, 48, 58, 64 and the laser beam generator (not shown). As can be seen from the attached drawings, the X-axis motion unit 12 can be moved along the racks 28 on the arm 20 of the frame 10 to effect cutting in the X-axis, and the Y-axis motion unit 14 can be moved within the X-axis motion unit 12 to effect cutting in the Y-axis. Both motions can occur at the same time to produce cuts which vary in both axes along the length thereof. The X2-axis motion unit 16 can also be moved on the Y-axis motion unit 14. Thus, two separate drives in the X- axis direction are provided and one drive is provided in the Y- axis direction. These drives can effect the motion of the cutting head 42 in both X- and Y-axes simultaneously. The cutting head 42 can also be moved vertically in the Z-axis to focus the laser beam on the workpiece.

The computer control 30 can also activate the drive motor 38 to move the X-2 motion unit 16 in the X-axis relative to the X-axis motion unit 12 and Y-axis motion unit 14. Thus, when only a small X-2 motion in the X-axis for the cutting action is required, that motion may be effected by the relative movement of only the X-2 axis motion unit 16, and that motion is faster for the same movement than the speed of the X-axis motion unit 12 due to the lesser inertia. Because there is less mass to be moved and stopped, movement of the X-2 axis motion unit 16 also tends to provide better quality cutting action for intricate contours. If a large displacement along the X-axis is required to reposition the laser cutting head 42 relative to the workpiece, or if the length of the cut exceeds the range of motion of the X2-axis motion unit 16, the computer control 30 will activate the motors 64 to move the X- axis motion unit 12. On occasion, both X-axis drives may be operated simultaneously.

Discussion on the laying out of the parts contours and determination when X2-axis motion should be used will be found in the aforementioned application Ser. No. 10/156,886 filed May 2, 2002. Generally, the layout of the parts on the workpiece is done off-line using CAD software, and the layout program is then transferred to the machine tool computer.

The entire machining tool installation can be disposed within a protective enclosure if so desired. The power supply cables for the several motors are supported on the frame so that the X-axis motion unit can move back and forth along the length of the frame. The same is true with respect to tubing for supplying cutting or shielding gas to the laser cutting head. The optics are mounted on the frame so that the laser beam travels in bellows enclosures to the cutting head.

It will be readily appreciated that the addition of the second drive in the X-axis affords significant advantages in time for operation, quality of cutting action and wear on the larger machine parts. The X-axis motion unit carries the mass of itself and the other motion units and it typically requires a relatively powerful motor to effect its motion along the length of the worktable. In contrast, a small X2-axis motion unit containing the laser cutting head can be relatively light and can be moved very quickly with relatively little inertia to be overcome. As a result, the laser cutting action afforded by movement of the small housing is more precise, particularly when there are changes in direction. The computer control software can easily manage the cutting procedure and synchronize the motion in both X- and Y-axes and the superposition of the motion possible in the Z-axis in order to best process the workpiece.

In a commercial embodiment of the present invention, the range of motion of the small axis housing is 300 mm, but longer ranges may be readily provided.

The software will normally evaluate all cuts within the numeric control program including absolute position, relative position to each other and overall size of each part. The overall size will determine which cuts will fit within the working range of the X2-axis motion unit; the relative position of the contours to each other will define how many consecutive parts can be cut with the X2-axis motion unit without moving the X-axis motion unit along the frame; and the absolute position defines the base position for the X-axis motion unit at the start of any given action.

With this information in hand, the machine control positions both the motion units in axes during the movement to the next cut. The motion unit will be placed so that the maximum possible number of cuts can be effected by the X2-axis motion unit without moving the X-axis motion unit on the frame. When the program determines that the contour of a part falls outside this envelope, the motion unit is moved to a new base position for the next series of cuts utilizing only the motion of the X-axis motion unit. Thus, the software will optimize the process by minimizing the movements of the X-axis motion unit and the cutting required by motion of the X-axis motion unit and by concurrently maximizing the cutting which is accomplished by the motion of the X2-axis motion unit. If a contour is of a length which exceeds the working range of the motion for the X2-axis motion unit, there are several possibilities:
1. The contour of the part in the X-axis can be cut completely by using the motion of the X-axis motion unit.
2. The large contour in the X-axis can be split into several smaller segments which can be cut by use of the X2-axis motion unit with the X-axis motion unit being periodically moved.
3. Obviously another potential solution is to reorient the parts on the workpiece so that the length in the X-axis is within the range of motion of the X2-axis motion unit as indicated previously.

Thus, it can be seen from the foregoing detailed specification and attached drawings that the machine tool of the present invention is one which provides relatively rapid machining action by minimizing the motion required of the large motion unit on which the machining tool is supported. Moreover, since the machining tool on the X2-axis motion unit can be moved very quickly in the X-axis and relatively small mass is required to be moved, the cutting action can be more precise in the cutting of complex contours. The reduction in motion of the X-axis motion unit also provides a longer-lived installation and reduces the cost of operation.

1. A machine tool for machining workpieces by motion of a machining tool relative to a workpiece comprising:
(a) a worktable having X and Y axes and adapted to support a workpiece thereon;
(b) a machine frame having an arm extending over said worktable;
(c) an X-axis motion unit mounted on said arm and movable along said arm in the X-axis of said worktable in a first range of motion;
(d) first machining tool mounting means movably mounted on said X-axis motion unit for movement therealong in said Y-axis in a second range of motion;
(e) second machining tool mounting means movably mounted on said first machining tool mounting means for movement in said X-axis relative to said X-axis motion unit within a third range of motion of lesser length than, and within the length of, said first range of motion;
(f) a machining tool mounted on said second machining tool mounting means;
(g) first drive means for said X-axis motion unit for movement on said frame in said X-axis over said worktable in said first range of motion;
(h) second drive means for said first machining tool mounting means to move said first machining tool mounting means in said Y-axis along said X-axis motion unit in said second range of motion;
(i) third drive means for moving said second machining tool mounting means in said X-axis relative to said first machining tool mounting means in said third range of motion; and
j) a computer control for effecting operation of said first and second drive means to move said machining tool in said X and Y axes and for effecting operation of said third drive means for rapid movement of said machining tool in the X-axis to machine a workpiece supported on said worktable.

2. The machine tool in accordance with claim 1 wherein said machining tool is supported on said second machining tool mounting means for vertical movement in a Z-axis in a fourth range of motion and said machine tool includes fourth drive means for moving said machining tool in said Z-axis, said computer control also effecting operation of said fourth drive means.

3. The machine tool in accordance with claim 1 wherein said computer control includes means for determining whether a desired length of movement in said X-axis is within said third range of motion of said second machining tool mounting means on said first machining tool mounting means to effect the desired movement by said third drive means.

4. The machine tool in accordance with claim 1 wherein said computer control includes means for determining whether a desired length of movement in said X-axis is beyond said third range of motion of said second machining tool mounting means and for effecting the desired movement of the machining tool in said X-axis by operation of said first drive means to move said X-axis motion unit and by operation of said third drive means to move said second machining tool mounting means.

5. The machine tool in accordance with claim 1 wherein said computer control includes means for effecting a large displacement of said X-axis motion unit in said X-axis to reposition said machining tool relative to the workpiece and thereafter for effecting a smaller displacement of said second machining tool mounting means in said X-axis to effect machining of the workpiece in the X-axis.

6. The machine tool in accordance with claim 1 wherein said machining tool is a laser cutting head.

7. The machine tool in accordance with claim 1 wherein said machining tool is mounted in a housing providing said second machining tool mounting means and slidable on guides supported on a housing providing said first machining tool mounting means and movable on said support in said X- axis.

8. A laser cutting machine tool for laser cutting of workpieces by motion of a laser cutting head relative to a workpiece comprising:
(a) a worktable having X and Y axes and adapted to support a workpiece thereon;
(b) a frame having an arm extending over said worktable;
(c) an X-axis motion unit mounted on said arm extending transversely above said worktable movable on said arm along the X-axis of said worktable in a first range of motion;
(d) first tool mounting means movably mounted on said X-axis motion unit member for movement therealong in said Y-axis in a second range of motion;
(e) second machining tool mounting means movably mounted on said first machining tool mounting means for movement in said X-axis relative to said X-axis motion unit within a third range of motion of lesser length than, and within the length of, said first range of motion;
(f) a laser cutting head mounted on said second tool mounting means for vertical movement in a Z-axis;
(g) first drive means for said X-axis motion unit for movement on said frame in said X-axis over said worktable in said first range of motion;
(h) second drive means for said first tool mounting means to move said first machining tool mounting means in said Y-axis along said X-axis motion unit in said second range of motion;
(i) third drive means for moving said second tool mounting means in said X-axis relative to said first machining tool mounting means in said third range of motion;
(1) fourth drive means for moving said machining tool in said Z-axis; and
(k) a computer control for effecting operation of said first and second drive means to move said laser cutting head in X and Y axes and for effecting operation of said third drive means for rapid movement of said cutting head in the X-axis and for operation of said fourth drive means to move said cutting head in the Z-axis, said computer control including means for determining whether a desired length of movement in the X-axis is within said third range of motion of said second machining tool mounting means on said first machining tool mounting means to effect the desired movement by said third drive means and also including means for determining whether a desired length of movement in the X-axis is beyond said third range of motion of said second tool mounting means and for effecting the desired movement of the laser cutting head in the X-axis by operation of said first drive means to move said support member and thereafter by operation of said third drive means to move said second tool mounting means.

9. The laser cutting machine tool in accordance with claim 8, wherein said computer control includes means for effecting a large displacement of said support member in the X-axis to reposition said machining tool relative to the workpiece and thereafter for effecting a smaller displacement of said second machining tool mounting means in said X-axis to effect machining of the workpiece in the X-axis.

10. The laser cutting machine tool in accordance with claim 8, wherein said laser cutting head tool is mounted in a housing providing said second machining tool mounting means and slidable on guides supported on a housing providing said first tool mounting means and movable on said motion unit in the X-axis.
